(19) United States
(12) Patent Application Publication
(10) Pub. No.: US 2003/0227830 A1
(43) Pub. Date: Dec. 11, 2003

(54) Method for recording information, in particular audio signals, received via radio, in particular broadcast radio

(75) Inventor: Volker Lauke, Hohenhameln (DE)

Correspondence Address: KENYON & KENYON, ONE BROADWAY, NEW YORK, NY, 10004, US

(73) Assignee: Robert Bosch GmbH

(21) Appl. No.: 10/456,431

(22) Filed: Jun. 6, 2003

(30) Foreign Application Priority Data
Jun. 7, 2002 (DE) 102 25 623.3

(51) Int. Cl. H04H 9/00

(52) U.S. Cl. 369/7

(57) ABSTRACT

A method for storing information, in particular audio signals, received via radio, in particular broadcast radio, in which the information is delayed by a predetermined delay time and the delayed information is recorded in a second memory in response to a record command. As a result, even when playback of information which is of interest to the user has already begun, the latter can nevertheless record the entire information unit, for example the whole piece of music, part of which has already been played back, in its entirety right from the beginning.

### FIELD OF THE INVENTION

The present invention is directed to a method for recording information, in particular audio signals, received via radio, in particular broadcast radio.

### BACKGROUND INFORMATION

Broadcast radio receivers in the form of car radios having a traffic message recording function may be used, in which audio signals received via broadcast radio, here in the form of spoken traffic messages, are stored in an audio signal memory of the device in response to a traffic message identifier that accompanies the traffic reports and is also broadcast by radio. When its capacity is exceeded as a result of newly received traffic messages, the memory of the device may be regularly overwritten by the latest messages. The currently stored traffic messages can be recalled when desired by the user and reproduced acoustically.

Particularly from the field of home entertainment electronics, recording devices may be used by which (audio) signals received via broadcast, for example radio or television broadcast, can be recorded from the current program.

### SUMMARY OF THE INVENTION

The exemplary method according to the present invention is believed to have the advantage that even when the playback of an audio signal which interests the user or the transmission of information has already begun, the user is nevertheless able to completely record the entire audio signal unit or information unit, for example, the complete piece of music which has already been partially played back.

For this purpose, according to the exemplary embodiment and/or method of the present invention, all information received via radio, in particular broadcast radio, is delayed by a predetermined delay time, and the information delayed by the delay time or a part thereof is recorded in a second memory in response to a record command.

Advantageously, the information received via radio is delayed using a first memory in which the received information is buffered, and the delayed information may be received at its output, the delayed information buffered in the first memory or a part thereof being recorded in the second memory in response to the record command.

According to another exemplary embodiment and/or method, additional received information, which together with the information buffered in the first memory forms an information unit, is also recorded in the second memory in response to a single record command after being delayed using the first memory. In this way, complete information units are always recorded in the second memory if the record command has been given within the predetermined delay time after the start of reception of the information unit.

According to an exemplary embodiment of the present invention, a buffer (“shock proof memory”) such as those used frequently in playback devices for disk-shaped recording media, such as CDs or DVDs, intended for mobile use for the error correction of the information read from the disk-shaped recording media may also be used as a first memory. The forenamed playback devices intended for mobile use are thus often subjected to shocks which cause errors in reading the recording media, which are in turn audible in the audio signal played back. A temporary buffering of the audio signals read in a “shock proof memory” is frequently able to eliminate such read errors.

Another exemplary embodiment of the present invention is directed at not starting the recording of the delayed received information in response to the record command until the start of the information unit is recognized within the delayed information signal. Thus, as is later shown in connection with the description of the embodiments, the buffer contains parts of different information units at specific points in time of observation. The effect of the exemplary embodiment and/or method is that, together with an information unit just received, which is to be recorded, only its beginning but not residues of an older information unit that may still be present in the buffer is written to the second memory.

### BRIEF DESCRIPTION OF THE DRAWINGS

FIG. 1 shows a schematic diagram of the part of a car radio of an exemplary embodiment of the present invention, as an example of a system for performing the exemplary method according to the present invention.

FIG. 2 shows a schematic depiction of the process of recording information received via radio, an audio signal in particular.

### DETAILED DESCRIPTION

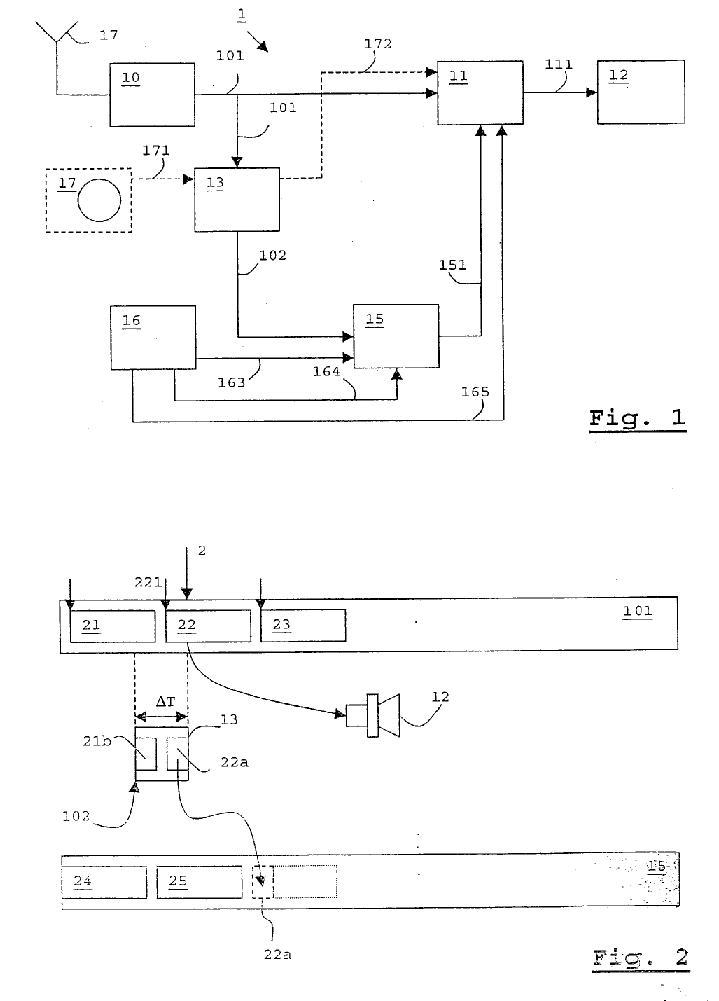

FIG. 1 shows a schematic diagram of a radio receiver 1 for carrying out the exemplary method of the present invention, using the example of a car radio that is designed to receive frequency modulated radio signals in the VHF frequency band. The modulation content of these VHF broadcast signals regularly includes radio program signals 101 intended for acoustic playback, i.e., audio signals, also including pieces of music 21, 22, 23.

A mixture of VHF reception signals receivable at the receiving location, that are present at a receiving antenna 17, is conducted to a receiving section 10 of the car radio. In an available manner, receiving section 10 has the circuitry for selecting and demodulating a particular one of the receivable VHF reception signals. Accordingly, modulation content 101 of the selected and demodulated VHF reception signal, i.e., the actual radio program, is present at the output of receiving section 10.

In a broadcast playback mode, continuously received radio program 101 is played back through a source selector switch 11 as playback signal 111 through a playback device 12. For this purpose, in an available manner, playback device 12 has the necessary arrangement for providing volume adjustment and amplification and for influencing the sound of playback signal 111 if appropriate, as well as attached speakers for converting playback signal 111 to a sound event. Source selector switch 11 is switched among various playback modes by a control unit 16 of the car radio that includes control elements, using a source selection signal 165. In the present case, for example, provision is made for switching between CD or DVD playback (corrected CD or DVD audio signal 172, if appropriate), broadcast playback mode (radio program signal 101), or playback of audio signals 151 recorded in a second memory 15, for example a multi-media card (MMC). Depending on the desired playback mode, source selector switch 11 routes one of the forenamed audio signals, radio 101, MMC 151 or CD 172, as directed by source selector signal 165, to the input of playback device 12 as playback signal 111 for playback.

Continuously received radio program 101 is also delayed for a specific period of time ΔT in a delay unit 13. The delay unit may be arranged as a buffer operating according to the FIFO (first in first out) principle. This first memory 13 may have limited storage capacity, so that it is able to buffer an audio signal segment of 30 seconds in length, for example. One peculiarity of the function of first memory 13 is that in the event that its storage capacity is completely exhausted by recorded audio signals, the oldest of the recorded signals are overwritten by newly received audio signals. Consequently, at any given moment of observation the audio signals received in the last 30 seconds are stored in first memory 13; information 102 delayed by 30 seconds is present at its output at any given point in time (after a recharging time within the scope of its storage capacity).

According to an exemplary embodiment of the present invention, in the described broadcast playback mode in which the received radio program is played back through speakers connected to the car radio, a “shock proof memory” is used as first memory 13. The “shock proof memory” is a buffer memory for temporary storage of audio signals 171 read from an audio signal medium in disk format, for example a compact disk (CD) or digital versatile disk (DVD) or the like. Such a recorded data medium in disk format and the associated reading device is widely used in present-day car radios, and is marked with the reference symbol 17 in FIG. 1. Disk reading devices are sensitive to shock. As a result of shocks to the reading devices, errors occur in reading the disk media, which result in audibly deficient audio signals. For that reason, an earlier patent application of the present applicant proposed that read out audio signals 171 be delayed or buffered in the forenamed “shock proof memory” and the stored data be used for the purpose of error correction if necessary. The storage capacity of the “shock proof memory” used for that purpose may normally be in the range of some tens of seconds, for example 30 seconds.

The above-described radio receiver 1 also has a recording function, described in greater detail below, for recording audio signals received via radio on another recording medium, for example, an MMC (multimedia card), MiniDisc™, hard disk drive or the like, which is represented in the figure by second memory 15.

Received audio signal (radio program signal) 101 is conducted for this purpose as delayed audio signal 102 from the output of delay element 13 or first memory 13 to second memory 15.

After a record command 2 is initiated by the user through control unit 16, control unit 16 sends a record release signal 163 to second memory 15, which is thus released to record the delayed information present at the output of delay element 13.

According to another embodiment of the present invention, the recording of the delayed information present at the output of delay element 13 in second memory 15 is not started until a beginning marker 221 for an information unit 22 is recognized within the delayed information signal or the start of the information unit is detected elsewhere. In the case of a receiver for digital broadcast signals, beginning and/or end markers may be transmitted for audio signal units by radio. These may be detected and used to trigger the recording process in second memory 15. In the event that it is not possible to receive a beginning marker via the received radio signal, as an alternative to the detection of the start of an information or audio signal unit, a zero level detection may be performed, the start of an information unit being recognized by the fact that the level of the audio signal is below a specified value for a predetermined length of time.

This embodiment of the present invention prevents components 21b of an older information unit still present in the buffer, which are chronologically earlier than the start of the information unit of interest, from being written to second memory 15 together with the information unit of interest. Instead, according to this embodiment, the recording is not started until the start of information unit 22 of interest.

In a similar manner, a limit stop of the recording in second memory 15 may be performed based on an end marker of information unit 22 contained in the received signal or another zero level detection. Accordingly, the recording is then stopped automatically if a processor (not shown) of device 1 has recognized an end marker in delayed signal 102. As an alternative, an end marker in undelayed received signal 101 may be analyzed, it not being permissible for the stop to occur until after an additional time period ΔT corresponding to the delay of delay element 13.

In the “XM” and “SIRIUS” satellite broadcast systems operated in the USA, progress and length information is transmitted in addition to pieces of music. This information may also be used in conjunction with a clock within the device to automatically stop the recording in second memory 15.

However, according to another embodiment of the present invention, the recording of the information present at the output of the delay stage in second memory 15 may be started immediately in response to the record command and to stop it manually by a record stop command, the user may enter the record stop command as a response to the audible end of playback of a piece of music, with the recording taking place after an additional period of time ΔT corresponding to the delay of delay element 13.

The delayed information present at the output of first memory 13 is stored in second memory 15 at the next open address after previously stored information, such as pieces of music 24, 25. If record command 2 is given within a time span which corresponds to specified delay time ΔT of delay element 13, after the start of the information unit presently being received and recorded, entire information unit 22 including its start 22a is consequently recorded in second memory 15, although its playback via the device's speakers is already chronologically earlier (FIG. 2).

Therefore, even if the user initiates a record command at control unit 16 only after playback of an audio signal received via radio has begun, in particular for example a piece of music, the described recording process nevertheless causes entire audio signal unit 22, in particular entire music piece 22, to be recorded in second memory 15, including its beginning, which preceded the triggering command in time.

However, that requires the record command to be given at control unit 16 by the user within the recording period after the beginning of the audio signal received by radio specified by the capacity of first memory 13. A recording capacity of first memory 13 of about 30 seconds appears to be adequate for this purpose.

An arrangement for blocking the recording may be provided for cases where the record command is not given within the period after the beginning of the audio signal specified by the recording capacity of first memory 13. Consequently, audio signal units whose beginning is no longer available due to the limited capacity of first memory 13 are not recordable in second memory 15.

By using an appropriate selection command via control unit 16, instead of a current radio transmission or a CD or DVD signal, the audio signal stored in second memory 15 may be played back via source selector switch 11 and playback unit 12. To this end, control unit 16 generates a corresponding selection control command 164 to control second memory 15 to emit the stored audio signal, and a corresponding source selection command 165 to switch source selector switch 11 over to the output of second memory 15.

Second memory 15 may be advantageously implemented for example as a card read/write device for memory chip cards, in particular for example for an MMC (multi media card) with embedded storage medium (MMC).

Particularly advantageous may be an implementation of second memory 15 in which the actual storage media are exchangeable, as in the case of the MMC. An alternative implementation of second memory 15 may be, for example, a read/write device for the essentially-known MiniDisc™ (MD), where the MiniDisc may be utilized as a replaceable storage medium. Alternatively, second memory 15 may be implemented for example in the form of a removable hard drive, or a miniature hard drive such as the Microdrive™.

Even though the described exemplary embodiment is directed substantially at a car radio for receiving FM-modulated radio broadcast signals transmitted in the VHF band having an integrated CD or DVD playback device, this is not intended to limit the object of the exemplary embodiment and/or method of the present invention in any way. Rather, the exemplary embodiment and/or method of the present invention may also be applicable to all radio receivers, whether for example to radio receivers for digital broadcasts such as DAB (digital audio broadcasting), satellite radio or the like. In the case of coded audio signals, in particular those transmitted in compressed form, for example according to MPEG-2, MPEG-3 or some other standard, these signals may also be written advantageously in compressed form to first and second memories 13, 15. This may permit improved memory utilization, and consequently greater memory capacity, in the case of first memory 13 in particular a longer response time for the user to enter the record command after playback of the audio signal being received has begun. In this case, the decoding may be integrated into playback unit 12, to which the audio signals that are present in coded form are supplied for the purpose of playback.

The above exemplary embodiments were described primarily on the basis of audio signals or music pieces. This is not intended to be understood as a restriction to audio signals, however, but rather any other type of information may also be recorded in the same manner, including, for example, video information or information from data services, such as traffic messages transmitted in coded form, for example.

What is claimed is:

1. A method for recording audio signal information, the method comprising:
receiving the audio signal information via broadcast radio, wherein the information is delayed by a predetermined delay time; and
recording at least a part of the delayed information in a second memory in response to a record command.

2. The method of claim 1, wherein the information is delayed using a first memory in which the received information is buffered, and the delayed information is receivable at its output, and the delayed information buffered in the first memory or a part thereof is recorded in the second memory in response to the record command.

3. The method of claim 2, wherein additional received information, which together with the information buffered in the first memory forms an information unit, is also recorded in the second memory after being delayed using the first memory.

4. The method of claim 2, wherein a buffer of a playback device for a disk-shaped recording media is used as the first memory.

5. The method of claim 1, wherein the recording of the delayed information received in response to the record command is not started until a start of an information unit is recognized within a signal corresponding to the delayed information.

6. The method of claim 1, wherein the recording in the second memory is ended automatically if an end marker of an information unit is recognized in a delayed information signal received or if a time span corresponding to the predetermined delay time has passed after a recognition of an end marker in a received un-delayed signal.

7. The method of claim 4, wherein the disk-shaped recording media is one of a CD and a DVD.

8. The method of claim 4, wherein the playback device is integrated into the radio receiver.
